(19) United States
(12) Patent Application Publication
(10) Pub. No.: US 2026/0241700 A1
(43) Pub. Date: Aug. 20, 2026

(54) LIQUID CIRCULATION DEVICE AND LIQUID DISCHARGE APPARATUS

(71) Applicants: Takahiro YOSHIDA, Kanagawa (JP); Yuuta AOKI, Kanagawa (JP)

(72) Inventors: Takahiro YOSHIDA, Kanagawa (JP); Yuuta AOKI, Kanagawa (JP)

(73) Assignee: Ricoh Company, Ltd., Tokyo (JP)

(21) Appl. No.: 19/535,083

(22) Filed: Feb. 10, 2026

(30) Foreign Application Priority Data
Feb. 20, 2025 (JP) 2025-025553

(51) Int. Cl. B41J 2/18; B41J 2/175

(52) U.S. Cl. CPC B41J 2/18; B41J 2/17596

(57) ABSTRACT

A liquid circulation device is provided that includes: a supply unit including a supply tank to store a liquid to be supplied to a supply target, and a collection tank to store the liquid collected from the supply target; a liquid feed pump to feed the liquid from the collection tank to the supply tank; a positive pressure pump to supply gas to the supply tank; a negative pressure pump to suck gas from the collection tank; and an air feed pump to supply the gas in the supply tank into the collection tank. The supply unit supplies the liquid to the supply target by a differential pressure between the supply tank and the collection tank.

### CROSS-REFERENCE TO RELATED APPLICATIONS

This patent application is based on and claims priority pursuant to 35 U.S.C. § 119(a) to Japanese Patent Application No. 2025-025553, filed on Feb. 20, 2025, in the Japan Patent Office, the entire disclosure of which is hereby incorporated by reference herein.

### BACKGROUND

### Technical Field

The present disclosure relates to a liquid circulation device and a liquid discharge apparatus.

### Related Art

A liquid circulation device that supplies liquid to a supply target is known. There is also known a liquid discharge apparatus including the liquid circulation device and a liquid discharge head that discharges liquid supplied from the liquid circulation device.

For example, there is known a liquid circulation device that generates a differential pressure between a tank on the negative pressure collection side and a tank on the positive pressure supply side, transfers liquid from the supply-side tank to the collection-side tank via a liquid discharge head, and returns the liquid from the collection-side tank to the supply-side tank.

### SUMMARY

Embodiments of the present invention provides a liquid circulation device that includes: a supply unit including a supply tank to store a liquid to be supplied to a supply target, and a collection tank to store the liquid collected from the supply target; a liquid feed pump to feed the liquid from the collection tank to the supply tank; a positive pressure pump to supply gas to the supply tank; a negative pressure pump to suck gas from the collection tank; and an air feed pump to supply the gas in the supply tank into the collection tank. The supply unit supplies the liquid to the supply target by a differential pressure between the supply tank and the collection tank.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a diagram schematically illustrating a configuration of a liquid circulation device according to a first embodiment of the present invention;

FIG. 2 is a diagram illustrating flow rate changes of liquid or gas by a pump of the liquid circulation device according to the first embodiment of the present invention;

FIG. 3 is a diagram schematically illustrating a configuration of a liquid circulation device according to a second embodiment of the present invention;

FIG. 4 is a schematic explanatory view of a printing apparatus as an example of a liquid discharge apparatus according to a third embodiment of the present invention;

FIG. 5 is a block diagram illustrating a configuration of a printing unit in the liquid discharge apparatus according to the third embodiment of the present invention;

FIG. 6 is an explanatory plan view of a head unit of the liquid discharge apparatus according to the third embodiment of the present invention;

FIG. 7 is an external perspective explanatory view of a liquid discharge head of the liquid discharge apparatus according to the third embodiment of the present invention;

FIG. 8 is an explanatory cross-sectional view in a direction (i.e., liquid chamber longitudinal direction) orthogonal to a nozzle arrangement direction of the liquid discharge head of the liquid discharge apparatus according to the third embodiment of the present invention; and

FIG. 9 is a schematic view of an electrode manufacturing apparatus according to a fourth embodiment of the present invention.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise.

According to embodiments of the present invention, pulsation of the flow rate of liquid caused due to pressure fluctuation in the supply-side tank and the collection-side tank can be suppressed.

A liquid discharge apparatus according to embodiments of the present invention is described below with reference to the drawings. Note that the present invention is not to be considered limited to the following embodiments but can be changed within the range that can be conceived of by those skilled in the art, such as other embodiments, additions, modifications, and deletions, and the scope of the present invention encompasses any aspect, as long as the aspect achieves the operation and advantageous effect of the present invention.

### First Embodiment

### Configuration of Liquid Circulation Device According to First Embodiment

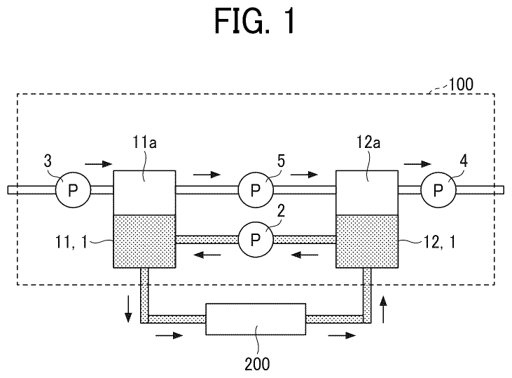

FIG. 1 is an explanatory diagram schematically illustrating a configuration of a liquid circulation device 100 according to a first embodiment of the present invention. Arrows in FIG. 1 indicate the direction of flow of liquid and gas.

The liquid circulation device 100 is a liquid circulation device that circulates liquid and supplies the liquid to a supply target 200. The liquid circulation device 100 includes a supply tank 11 that stores liquid to be supplied to the supply target 200 and a collection tank 12 that stores liquid collected from the supply target 200, and includes a supply unit 1 that supplies liquid to the supply target 200 by a differential pressure between the supply tank 11 and the collection tank 12. The liquid circulation device 100 includes a liquid feed pump 2 that feeds liquid from the collection tank 12 to the supply tank 11, a positive pressure pump 3 that supplies gas to the supply tank 11, a negative pressure pump 4 that takes in gas from the collection tank 12, and an air feed pump 5 that feeds gas in the supply tank 11 into the collection tank 12.

The liquid circulation device 100 is, for example, a device that is mounted on a liquid discharge apparatus and supplies liquid to a liquid discharge head of the liquid discharge apparatus. In this case, the liquid discharge head corresponds to the supply target 200.

The liquid circulation device 100 causes the supply unit 1 to supply liquid to the supply target 200 based on the differential pressure between the supply tank 11 and the collection tank 12. The liquid circulation device 100 can circulate the liquid by feeding the liquid collected from the supply target 200 from the collection tank 12 to the supply tank 11 by the liquid feed pump 2.

When the liquid is supplied toward the supply target 200 and the liquid in the supply tank 11 decreases, the volume of a gas space 11a of the supply tank 11 increases and the internal pressure of the supply tank 11 decreases. On the other hand, in the liquid circulation device 100, the internal pressure of the supply tank 11 is adjusted by operating the positive pressure pump 3 to supply gas to the supply tank 11.

Conversely, when the liquid is collected in the collection tank 12 and the liquid increases, the volume of a gas space 12a of the collection tank 12 decreases and the internal pressure of the collection tank 12 increases. On the other hand, in the liquid circulation device 100, the internal pressure of the collection tank 12 is adjusted by operating the negative pressure pump 4 to suck the gas in the collection tank 12.

When the liquid in the supply tank 11 decreases and the liquid in the collection tank 12 increases, the liquid is sent from the collection tank 12 to the supply tank 11 by the liquid feed pump 2. Driving of the liquid feed pump 2 to feed the liquid from the collection tank 12 to the supply tank 11 is referred to as liquid feeding operation by the liquid feed pump 2. When the liquid is supplied and the liquid in the supply tank 11 increases, the volume of the gas space 11a of the supply tank 11 decreases and the internal pressure of the supply tank 11 increases. On the other hand, when the liquid in the collection tank 12 decreases, the volume of the gas space 12a of the collection tank 12 increases, and the internal pressure of the collection tank 12 decreases.

In the liquid circulation device that supplies liquid to the supply target by the differential pressure between the supply tank and the collection tank, even when the positive pressure pump that supplies gas to the supply tank is operated, it may not be possible to reduce the internal pressure of the supply tank, and pulsation of the flow rate of the liquid may occur until the internal pressure is decreased by the decrease in the liquid. Similarly, even when the negative pressure pump that takes in gas from the collection tank is operated, it may not be possible to increase the internal pressure of the collection tank, and pulsation of the flow rate of the liquid may occur until the internal pressure is increased by the increase in the liquid.

In the liquid circulation device 100 according to the present embodiment, gas is supplied from the supply tank 11 to the collection tank 12 by the air feed pump 5. As a result, even when the liquid feed pump 2 operates to increase the liquid in the supply tank 11 and decrease the liquid in the collection tank 12, the gas in the gas space 11a is fed to the gas space 12a by the air feed pump 5. Since the gas in the gas space 11a is fed to the gas space 12a, increase in the internal pressure of the supply tank 11 and decrease in the internal pressure of the collection tank 12 are suppressed, and pulsation of the flow rate of the liquid is suppressed. As described above, in the present embodiment, the pulsation of the pressure caused due to the pressure fluctuation in the supply-side tank and the collection-side tank can be suppressed. Driving of the air feed pump 5 to cause the liquid to be fed from the supply tank 11 to the collection tank 12 is referred to as a liquid feeding operation by the air feed pump 5.

When the liquid feed pump 2 is not operated, the transfer of the liquid is stopped and the internal pressure of the supply tank 11 decreases, but the internal pressure of the supply tank 11 is adjusted by operating the positive pressure pump 3 to supply gas to the supply tank 11. Although the internal pressure of the collection tank 12 increases, the internal pressure of the collection tank 12 is adjusted by operating the negative pressure pump 4 to suck the gas in the collection tank 12.

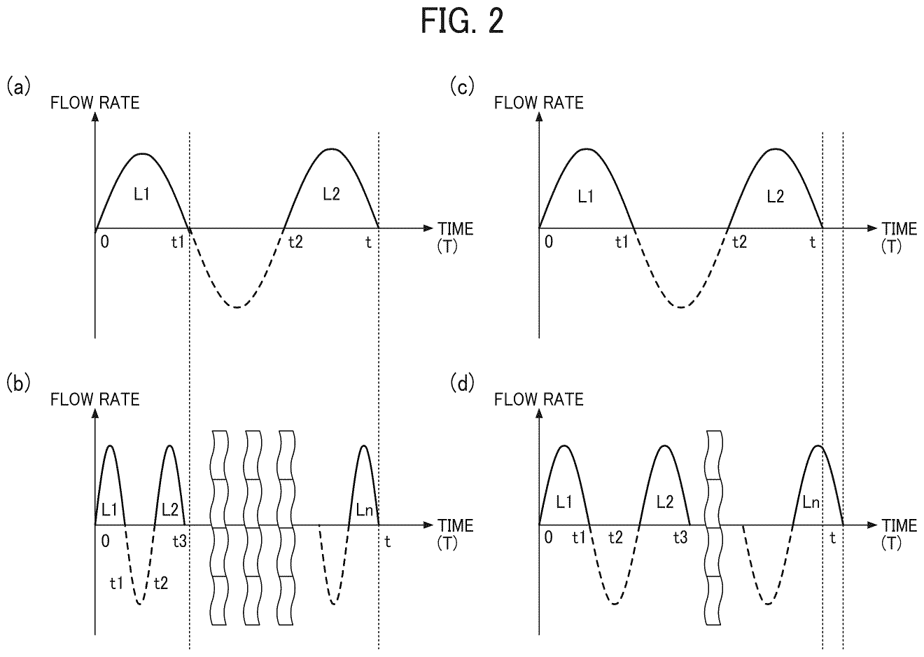

FIG. 2 is a diagram illustrating flow rate changes of liquid or gas by the pump of the liquid circulation device 100.

FIG. 2(a) illustrates a flow rate change of the liquid fed by the liquid feed pump 2. FIG. 2(b) illustrates a flow rate change of the gas supplied by the air feed pump 5. As illustrated in FIGS. 2(a) and 2(b), the positive pressure pump 3, the negative pressure pump 4, the liquid feed pump 2, and the air feed pump 5 operate periodically. The flow rate of the liquid or gas fed by each pump is not constant, and there is pulsation. In FIGS. 2(a) and 2(b), the vertical axis represents the flow rate of the pump, and the horizontal axis represents time. T=0 is a start timing of the liquid feeding operation and the air feeding operation, and T=t is an end timing of the liquid feeding operation and the air feeding operation.

In FIGS. 2(a) and 2(c), the flow rate at T=0 to T=t1 is an area L1 surrounded by the solid line of the waveform and the horizontal axis from T=0 to T=t1, and the flow rate at T=t2 to T=t is an area L2 surrounded by the solid line of the waveform and the horizontal axis from T=t1 to T=t2.

At this time, assuming that the flow rate from the start (T=0) to the end (T=t) of the liquid feeding operation is L_{A}, L_{A} is expressed by the following formula.

$${L}_{A} = L 1 + L 2$$

When a flow rate from the start (T=0) to the end (T=t) of the operation in FIGS. 2(b) and 2(d) is L_{B}, L_{B} is expressed by the following formula.

$${L}_{B} = L 1 + L 2 + ⋯ + Ln ( n is an interger of 3 or more )$$

In the present embodiment, it is preferable that the start timing of the liquid feeding operation of the liquid feed pump 2 and the start timing of the air feeding operation of the air feed pump 5 are both T=0. In other words, it is preferable that the start timing of the liquid feeding operation by the liquid feed pump 2 is equal to the start timing of the air feeding operation by the air feed pump 5. If the start timing of the liquid feeding operation by the liquid feed pump 2 and the start timing of the air feeding operation by the air feed pump 5 are the same, the timing of T=t may be different, with FIG. 2(c) illustrating the flow rate change of the liquid feed pump 2 and FIG. 2(d) illustrating the flow rate change of the air feed pump 5. Since the start timing of the liquid feeding operation of the liquid feed pump 2 is equal to the start timing of the air feeding operation of the air feed pump 5, it is possible to suppress the fluctuation of the amount of liquid and gas in the supply tank 11 and the amount of liquid and gas in the collection tank 12, and the pulsation of the flow rate of liquid is further suppressed.

It is preferable that the end timing of the liquid feeding operation by the liquid feed pump 2 is equal to the end timing of the air feeding operation by the air feed pump 5. Since the start timing of the liquid feeding operation of the liquid feed pump 2 and the start timing of the air feeding operation of the air feed pump 5 are the same, and the end timing of the liquid feeding operation of the liquid feed pump 2 and the end timing of the air feeding operation of the air feed pump 5 are the same, fluctuations in the amount of liquid and gas in the supply tank 11 and the amount of liquid and gas in the collection tank 12 are decreased. As a result, pulsation of the flow rate of the liquid is further suppressed. In the examples illustrated in FIGS. 2(a) and 2(b), the cycle of the liquid feeding operation is different from the cycle of the air feeding operation. However, since the start timings of the liquid feeding operation and the air feeding operation are the same and the end timings of the liquid feeding operation and the air feeding operation are the same, the pulsation of the flow rate of the liquid due to the pressure fluctuation in the supply-side tank and the collection-side tank is further suppressed.

It is preferable that the amount of liquid fed from the start of the liquid feeding operation by the liquid feed pump 2 to the end of the liquid feeding operation is the same as the amount of gas fed from the start of the air feeding operation by the air feed pump 5 to the end of the air feeding operation. The flow rate L_{A} from the start (T=0) to the end (T=t) of the liquid feeding operation of the liquid feed pump 2 and the flow rate L_{B} from the start (T =0) to the end (T=t) of the air feeding operation of the air feed pump 5 preferably satisfy the relationship of the following formula.

$${L}_{A} = {L}_{B}$$

Since the amount L_{A} of the liquid fed by the liquid feed pump 2 during the liquid feeding operation is the same as the amount L_{B} of the gas fed by the air feed pump 5 during the air feeding operation, it is possible to suppress fluctuations in the amount of the liquid and the gas in the supply tank 11 and the amount of the liquid and the gas in the collection tank 12, and pulsation of the flow rate of the liquid is further suppressed.

It is preferable that the phase of the flow rate change of the liquid fed by the liquid feeding operation of the liquid feed pump 2 and the phase of the flow rate change of the liquid fed by the air feeding operation of the air feed pump 5 are the same phase. For example, assuming that the phase diagram of the liquid feed pump 2 and the phase diagram of the air feed pump 5 are both FIG. 2(a), the amounts of liquid and gas in the supply tank 11 and the amounts of liquid and gas in the collection tank 12 can be kept constant, and pulsation of pressure can be further suppressed.

### Second Embodiment

Next, a liquid circulation device according to a second embodiment of the present invention will be described. In the following description, names and reference signs similar to those described above denote like or equivalent components, and a detailed description thereof may be omitted as appropriate. The same applies to the embodiments described below.

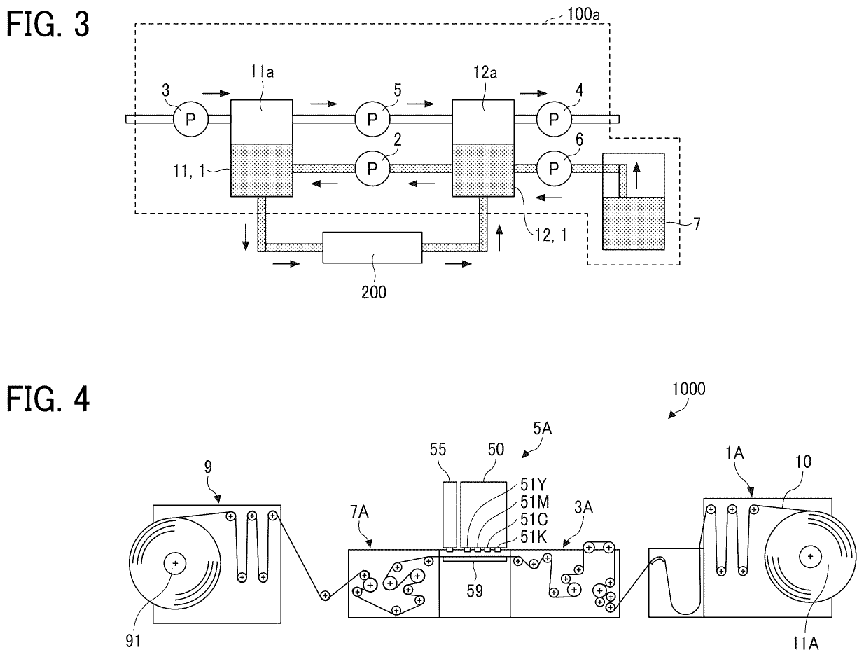

FIG. 3 is a diagram schematically illustrating another example of the configuration of the liquid circulation device according to the second embodiment of the present invention.

FIG. 3 is an explanatory diagram schematically illustrating a configuration of a liquid circulation device 100a according to the second embodiment. Arrows in FIG. 3 indicate the direction of flow of liquid and gas.

The liquid circulation device of the present embodiment includes a replenishment tank 7 that stores liquid to be replenished to the collection tank 12, and a replenishment pump 6 that replenishes liquid from the replenishment tank 7 to the collection tank 12.

Here, for example, when the supply target 200 is a liquid discharge head that discharges liquid, the amount of liquid in the liquid circulation device decreases by discharging liquid from the liquid discharge head. The reduced liquid needs to be replenished. At this time, in accordance with the replenishment of the liquid, the amount of the liquid in the collection tank may increase, the pressure in the collection tank may increase, and pulsation of the flow rate of the liquid may occur. For example, similarly to the positive pressure pump 3, the negative pressure pump 4, the liquid feed pump 2, and the air feed pump 5, the replenishment pump 6 is periodically driven, the flow rate is not constant, there is pulsation, and a flow rate change as illustrated in FIGS. 2(a) and 2(b) occurs.

In the present embodiment, the start timings of the intake operation of the negative pressure pump 4, the liquid feeding operation of the liquid feed pump 2, the air feeding operation of the air feed pump 5, and the replenishment operation of the replenishment pump 6 are equal to each other. In the phase diagrams of FIGS. 2(a) and 2(b), the start timing of each of the intake operation of the negative pressure pump 4, the liquid feeding operation of the liquid feed pump 2, the air feeding operation of the air feed pump 5, and the replenishment operation of the replenishment pump 6 is preferably T=0. Since the start timings are the same, it is possible to suppress fluctuations in the amounts of liquid and gas in the supply tank 11 and the amounts of liquid and gas in the collection tank 12, and pulsation of the flow rate of liquid is further suppressed.

It is preferable that the respective end timings of the intake operation of the negative pressure pump 4, the liquid feeding operation of the liquid feed pump 2, the air feeding operation of the air feed pump 5, and the replenishment operation of the replenishment pump 6 are equal to each other.

Since the start timing and the end timing of each of the intake operation of the negative pressure pump 4, the liquid feeding operation of the liquid feed pump 2, the air feeding operation of the air feed pump 5, and the replenishment operation of the replenishment pump 6 are the same, it is possible to suppress fluctuations in the amount of liquid and gas in the supply tank 11 and the amount of liquid and gas in the collection tank 12, and pulsation of the flow rate of liquid is further suppressed.

For example, when FIG. 2(a) is a phase diagram of the negative pressure pump 4 and a phase diagram of the liquid feed pump 2, and FIG. 2(b) is a phase diagram of the air feed pump 5 and the replenishment pump 6, although the phases are different, the timing of the start and end of the liquid feeding operation and the timing of the start and end of the air feeding operation are the same, so that the pulsation of the flow rate of the liquid due to the pressure fluctuation in the supply-side tank and the collection-side tank is further suppressed.

It is preferable that the amount of gas sucked from the start of the intake operation to the end of the intake operation by the negative pressure pump 4, the amount of liquid fed from the start of the liquid feeding operation to the end of the liquid feeding operation by the liquid feed pump 2, the amount of gas fed from the start of the air feeding operation to the end of the air feeding operation by the air feed pump 5, and the amount of liquid fed from the start of the replenishment operation by the replenishment pump 6 to the end of the replenishment operation are equal to each other.

FIG. 2(a) is a phase diagram of the liquid feed pump 2 and the negative pressure pump 4. FIG. 2(b) is a phase diagram of the air feed pump 5 and the replenishment pump 6. Assuming that the amount of liquid fed by the liquid feed pump 2 is L_{A}2, the amount of gas fed by the negative pressure pump 4 is L_{A}4, the amount of gas fed by the air feed pump 5 is L_{B}5, and the amount of gas fed by the replenishment pump 6 is L_{B}6, the relationship of the following formula is preferably established.

$${L}_{A} 2 = {L}_{A} 4 = {L}_{B} 5 = {L}_{B} 6$$

When this relationship holds, it is possible to suppress fluctuations in the amount of liquid and gas in the supply tank 11 and the amount of liquid and gas in the collection tank 12, and pulsation of the flow rate of liquid is further suppressed.

It is preferable that phases of the negative pressure pump 4, the liquid feed pump 2, the air feed pump 5, and the replenishment pump 6 are the same phase. For example, when FIG. 2(a) is a phase diagram of each of the negative pressure pump 4, the liquid feed pump 2, the air feed pump 5, and the replenishment pump 6, the amounts of liquid and gas in the supply tank 11 and the amounts of liquid and gas in the collection tank 12 can be kept constant, and pulsation of the flow rate of liquid is further suppressed.

### Third Embodiment

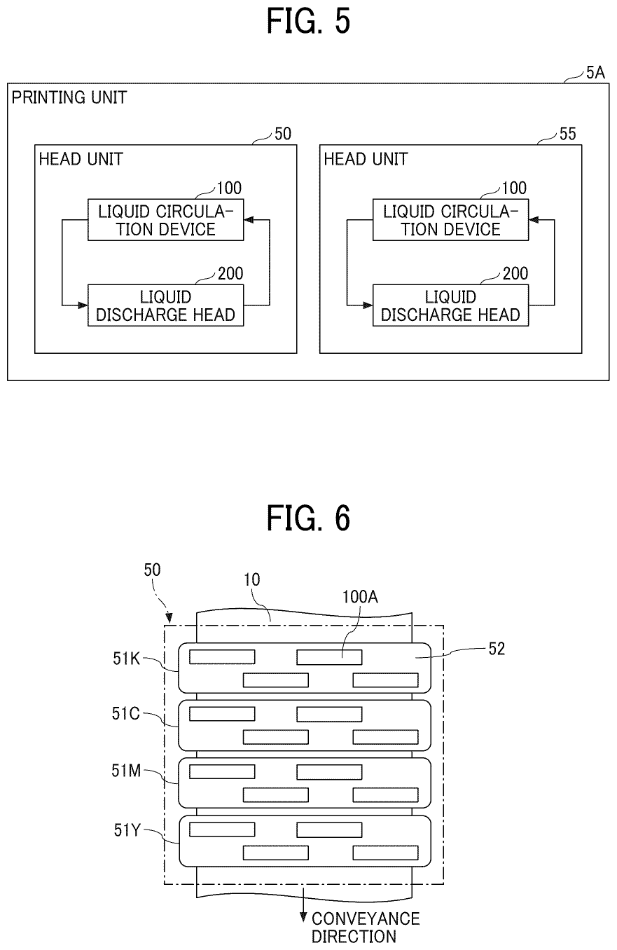

A liquid discharge apparatus according to a third embodiment of the present invention will be described with reference to FIGS. 4 and 5. FIG. 4 is a schematic explanatory view of a liquid discharge apparatus 1000 according to a third embodiment of the present invention. FIG. 5 is a block diagram illustrating a configuration of a printing unit 5A in the liquid discharge apparatus 1000.

A liquid discharge apparatus 1000 illustrated in FIG. 4 is a printing apparatus that discharges liquid to a continuous medium to which liquid to be discharged is applied (medium to be discharged) and forms an image on the continuous medium 10. The continuous medium is, for example, a continuous sheet which is a series of connected sheets.

The liquid discharge apparatus 1000 includes a carry-in unit 1A that carries in the continuous medium 10, a guide conveyance unit 3A that guides and conveys the continuous medium 10 carried in from the carry-in unit 1A to a printing unit 5A, a printing unit 5A that performs printing of discharging liquid onto the continuous medium 10 to form an image, a drying unit 7A that dries the continuous medium 10, and a discharge unit 9 that discharges the continuous medium 10. The printing unit 5A includes a head unit 50 that discharges liquid for forming an image and a head unit 55 that discharges processing liquid for performing post-processing. The head unit 50 and the head unit 55 include the liquid circulation device of the first embodiment or the second embodiment.

The continuous medium 10 is fed from an original winding roller 11A of the carry-in unit 1A, guided and conveyed by the respective rollers of the carry-in unit 1A, the guide conveyance unit 3A, the drying unit 7A, and the discharge unit 9, and wound by a winding roller 91 of the discharge unit 9.

In the printing unit 5A, the continuous medium 10 is conveyed on a conveyance guide member 59 so as to face the head unit 50 and the head unit 55, an image is formed by the liquid discharged from the head unit 50, and post-processing is performed by the processing liquid discharged from the head unit 55.

Here, the head unit 50 includes, for example, full-line head arrays 51K, 51C, 51M, and 51Y for four colors from the upstream side in a conveyance direction of the continuous medium. The full-line head arrays 51K, 51C, 51M, and 51Y may be referred to simply as the “head array 51” when colors are not distinguished.

Each of the head arrays 51 is a liquid discharge device to discharge liquid (e.g., ink) of black (K), cyan (C), magenta (M), or yellow (Y) onto the continuous medium 10 conveyed in the conveyance direction. The number and types of colors are not limited to the above-described four colors of K, C, M, and Y and may be any other suitable number and types.

In the head array 51, for example, as illustrated in FIG. 6, liquid discharge heads (hereinafter, also simply referred to as a “head”) 100A are arranged in a staggered manner on a base member 52, but are not limited thereto.

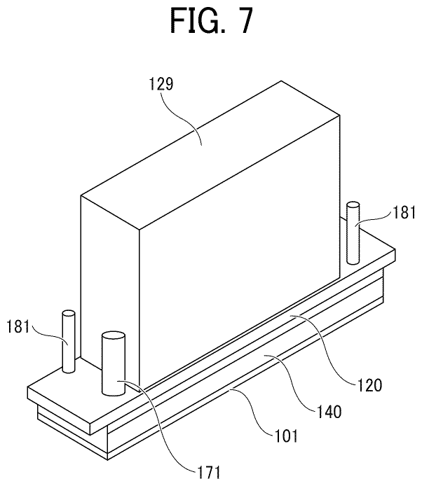

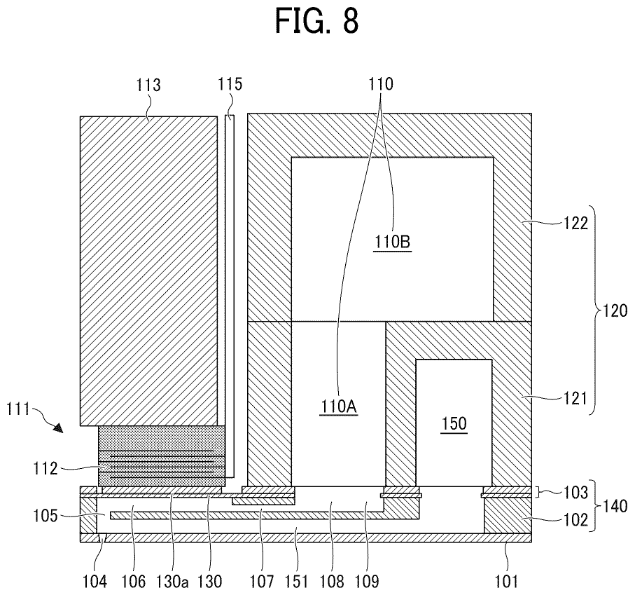

Next, an example of the liquid discharge head is described below with reference to FIGS. 7 and 8. In the present embodiment, the liquid discharge head is a circulation-type liquid discharge head. FIG. 7 is an external perspective explanatory view of the liquid discharge head. FIG. 8 is a cross-sectional explanatory view in a direction (liquid chamber longitudinal direction) orthogonal to a nozzle arrangement direction of the head.

The liquid discharge head includes a nozzle plate 101, a channel plate 102, and a diaphragm substrate 103 laminated one on another and bonded to each other. The diaphragm substrate 103 serves as a wall of a liquid chamber defined by the channel plate 102. The liquid discharge head further includes a piezoelectric actuator 111 to displace a vibration region (diaphragm) 130 of the diaphragm substrate 103, a common liquid chamber substrate 120 that also serves as a frame of the liquid discharge head, and a cover 129. A portion of the head 100 constructed by the channel plate 102 and the diaphragm substrate 103 is referred to as a channel substrate 140.

The nozzle plate 101 includes a plurality of nozzles 104 to discharge liquid.

The channel plate 102 has through holes and grooves that define individual liquid chambers 106, supply-side liquid restrictors 107, and liquid inlets 108. The individual liquid chambers 106 communicate with the nozzles 104 via nozzle communication channels 105, respectively. The supply-side liquid restrictors 107 communicate with the individual liquid chambers 106, respectively. The liquid inlets 108 communicate with the supply-side liquid restrictors 107, respectively. The nozzle communication channels 105 connect the nozzles 104 and the individual liquid chambers 106, respectively. The liquid inlets 108 communicate with a supply-side common liquid chamber 110 through openings 109 of the diaphragm substrate 103.

The diaphragm substrate 103 includes deformable vibration regions 130 serving as a wall of the individual liquid chambers 106 of the channel plate 102. Here, the diaphragm substrate 103 employs a two-layered structure (but not limited thereto) including, from the channel plate 102 side, the first layer forming a thin portion and the second layer forming a thick portion. The vibration region 130 that is deformable is formed at the portion of the first layer corresponding to the individual liquid chamber 106.

The piezoelectric actuator 111 is disposed on one side of the diaphragm substrate 103 opposite the other side facing the individual liquid chamber 106. The piezoelectric actuator 111 includes an electromechanical transducer as a driving device (actuator device or pressure generator) to deform the vibration region 130 of the diaphragm substrate 103.

The piezoelectric actuator 111 includes a piezoelectric element 112 bonded on a base member 113. The piezoelectric element 112 is grooved by half-cut dicing to form a comb shape including a desired number of pillar-shaped elements that are arranged at certain intervals.

The piezoelectric element 112 is bonded to a projection 130a, which is an island-shaped thick portion on the vibration region 130 of the diaphragm substrate 103. A flexible wiring board 115 is connected to the piezoelectric element 112.

The common liquid chamber substrate 120 defines the supply-side common liquid chamber 110 and a discharge-side common liquid chamber 150. The supply-side common liquid chamber 110 communicates with a supply port 171, and the discharge-side common liquid chamber 150 communicates with a discharge port 181.

Here, the common liquid chamber substrate 120 includes a first common liquid chamber substrate 121 and a second common liquid chamber substrate 122. The first common liquid chamber substrate 121 is attached to the channel substrate 140 on the diaphragm substrate 103 side and the second common liquid chamber substrate 122 is attached to and laminated on the first common liquid chamber substrate 121.

The first common liquid chamber substrate 121 defines a downstream common liquid chamber 110A and the discharge-side common liquid chamber 150. The downstream common liquid chamber 110A is a part of the supply-side common liquid chamber 110 communicating with the liquid inlets 108. The discharge-side common liquid chamber 150 communicates with discharge channels 151. The second common liquid chamber substrate 122 defines an upstream common liquid chamber 110B which is the other part of the supply-side common liquid chamber 110.

The channel plate 102 further defines the discharge channels 151 extending in the in-plane direction of the channel plate 102. The discharge channel 151 communicates with the individual liquid chambers 106 via the nozzle communication channels 105, respectively. The discharge channels 151 also communicate with the discharge-side common liquid chamber 150.

In the liquid discharge head, for example, the voltage to be applied to the piezoelectric element 112 is lowered from a reference potential (intermediate potential) so that the piezoelectric element 112 contracts to pull the vibration region 130 of the diaphragm substrate 103 to increase the volume of the individual liquid chamber 106. As a result, liquid flows into the individual liquid chamber 106.

Then, the voltage to be applied to the piezoelectric element 112 is increased to expand the piezoelectric element 112 in the direction of lamination, and the vibration region 130 of the diaphragm substrate 103 is deformed in a direction toward the nozzle 104 to reduce the volume of the individual liquid chamber 106. As a result, the liquid in the individual liquid chamber 106 is pressurized and discharged from the nozzle 104.

The liquid that has not been discharged from the nozzle 104 passes through the nozzle 104 and is fed to the discharge-side common liquid chamber 150 through the discharge channel 151. Then, the liquid is fed from the discharge-side common liquid chamber 150 to an external liquid circulation path (e.g., a liquid circulation device) and supplied to the supply-side common liquid chamber 110 again through the external liquid circulation path.

The method of driving the liquid discharge head is not limited to the above-described example (pull-push discharge). For example, pull discharge or push discharge may be performed in accordance with the way to apply a drive waveform.

The circulation-type liquid discharge head included in a liquid circulation device of the present embodiment may be an individual liquid chamber type head in which liquid circulates in the vicinity of nozzles, or may be a head in which liquid circulates only in a common liquid chamber.

In the present disclosure, the term “liquid discharge apparatus” includes a liquid discharge head and drives the liquid discharge head to discharge liquid, and is not limited to the printing apparatus illustrated in FIG. 1.

In the present disclosure, the liquid is not limited to a particular liquid as long as the liquid has a viscosity or surface tension to be discharged from a head (liquid discharge head). However, preferably, the viscosity of the liquid is not greater than 30 millipascal-second (mPa·s) under ordinary temperature and ordinary pressure or by heating or cooling. Specific examples of such liquid include, but are not limited to, solutions, suspensions, and emulsions containing solvents such as water and organic solvents, colorants such as dyes and pigments, functionality imparting materials such as polymerizable compounds, resins and surfactants, biocompatible materials such as deoxyribonucleic acid (DNA), amino acid, protein and calcium, and/or edible materials such as natural colorants. Such liquid can be used as inkjet inks, surface treatment liquid, liquid for forming compositional elements of electronic or luminous elements or electronic circuit resist patterns, and three-dimensional object forming material liquid.

In the “liquid discharge head”, examples of an energy source for generating energy to discharge liquid include a piezoelectric actuator (a laminated piezoelectric element or a thin-film piezoelectric element), a thermal actuator that employs an electrothermal transducer element, such as a thermal resistor, and an electrostatic actuator including a diaphragm and opposed electrodes.

The term “liquid discharge apparatus” used herein represents an apparatus that drives the liquid discharge head to discharge liquid. The term “liquid discharge apparatus” used here includes, in addition to apparatuses to discharge liquid to materials onto which liquid can adhere, apparatuses to discharge the liquid into gas (air) or liquid.

The “liquid discharge apparatus” may include devices to feed, convey, and eject the material on which liquid can adhere. The liquid discharge apparatus may further include a pretreatment apparatus to coat a treatment liquid onto the material, and a post-treatment apparatus to coat a treatment liquid onto the material, onto which the liquid has been discharged.

The “liquid discharge apparatus” may be, for example, an image forming apparatus to form an image on a sheet by discharging ink, or a three-dimensional fabrication apparatus to discharge a fabrication liquid to a powder layer in which powder material is formed in layers to form a three-dimensional fabrication object.

The term “liquid discharge apparatus” is not limited to an apparatus to discharge liquid to visualize meaningful images, such as letters or figures. For example, the liquid discharge apparatus may be an apparatus to form meaningless images, such as meaningless patterns, or fabricate three-dimensional images.

### Electrode Manufacturing Apparatus

The liquid discharge apparatus according to an embodiment of the present invention may also include an apparatus for manufacturing an electrode and an electrochemical element that is also referred to as an electrode manufacturing apparatus. The electrode manufacturing apparatus is described below.

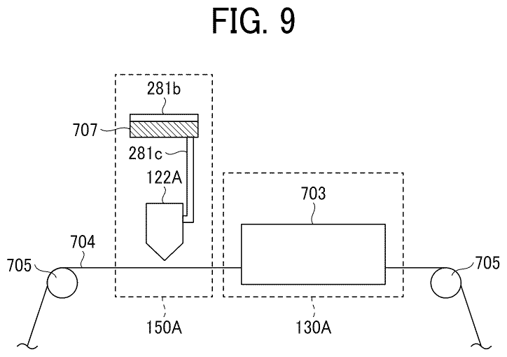

FIG. 9 is a schematic view of an electrode manufacturing apparatus according to a fourth embodiment. The electrode manufacturing apparatus is an apparatus for manufacturing an electrode including a layer containing an electrode material by discharging a liquid composition using a head module including the liquid discharge head 122A described in the first embodiment.

### Unit of Forming Layer Containing Electrode Material and Process of Forming Layer Containing Electrode Material

A discharge device in the electrode manufacturing apparatus illustrated in FIG. 9 is the head module according to the above-described embodiments of the present invention. The liquid discharge head of the head module discharges a liquid composition. By so doing, the liquid composition is applied onto a target, and a liquid composition layer is formed on the object. The target (hereinafter, may be referred to as “discharge target”) is not particularly limited and may be appropriately selected depending on the intended purpose, as long as the target is a target on which a layer containing an electrode material is to be formed. Examples of the target include an electrode substrate (current collector), an active material layer, and a layer containing a solid electrode material. The target may be an electrode composite layer containing an active material on an electrode substrate (current collector). A discharge device and a discharge process may be a device and a process of forming a layer containing an electrode material by directly discharging a liquid composition as long as the layer containing an electrode material can be formed on a discharge target. The discharge device and the discharge process may be a device and a process of forming a layer containing an electrode material by indirectly discharging a liquid composition.

### Other Configurations and Other Processes

Other configurations included in the electrode manufacturing apparatus for manufacturing an electrode composite layer are not limited to any particular configuration and may be appropriately selected depending on the intended purpose, as long as the effects of the embodiments of the present invention are not impaired. Other processes included in the method for manufacturing an electrode composite layer are not limited to any particular process and may be appropriately selected depending on the intended purpose, as long as the effects of the embodiments of the present invention are not impaired. For example, the heating device and the heating process are examples of the configuration and the process included in the manufacturing apparatus and the manufacturing method of the electrode composite layer.

### Heating Device and Heating Process

The heating device included in the manufacturing apparatus of an electrode composite layer is a device that heats the liquid composition discharged by the discharge device. The heating process included in the method for manufacturing an electrode composite layer is a process of heating the liquid composition discharged in the discharging process. The liquid composition is heated to dry the liquid composition layer.

### Structure to Form Layer Containing Electrode Material by Direct Discharge of Liquid Composition

As an example of the electrode manufacturing apparatus, an electrode manufacturing apparatus for forming an electrode composite layer containing an active material on an electrode substrate (current collector) is described below. As illustrated in FIG. 9, the electrode manufacturing apparatus includes a discharge process device 150A and a heating process device 130A. The discharging process device 150A performs a discharging process of applying a liquid composition onto a printing base material 704 having a discharge target to form a liquid composition layer. The heating process device 130A performs a heating process of heating the liquid composition layer to obtain an electrode composite layer.

The electrode manufacturing apparatus includes a conveyor 705 that conveys the printing base material 704. The conveyor 705 conveys the printing base material 704 to the discharge process device 150A and the heating process device 130A in this order at a preset speed. A method of producing the printing base material 704 having the discharge target such as an active material layer is not limited to any particular method, and a known method can be appropriately selected. The discharge process device 150A includes the liquid discharge head 122A that performs an application process of applying a liquid composition 707 onto the printing base material 704, a storage container 281b that stores the liquid composition 707, and a supply tube 281c that supplies the liquid composition 707 stored in the storage container 281b to the liquid discharge head 122A.

The discharge process device 150A discharges the liquid composition 707 from the liquid discharge head 122A so that the liquid composition 707 is applied onto the printing base material 704 to form a liquid composition layer in a thin film shape. The storage container 281b may be integrated with the electrode manufacturing apparatus that forms the electrode composite layer or may be detachable from the electrode manufacturing apparatus of the electrode composite layer. The storage container 281b may be a storage container used for adding to the storage container integrated with the manufacturing apparatus of the electrode composite layer or detachable from the manufacturing apparatus of the electrode composite layer.

The storage container 281b that stably stores the liquid composition 707 and the supply tube 281c that stably supplies the liquid composition 707 can be used.

The heating process device 130A performs a solvent removal process of heating and removing the solvent remaining in the liquid composition layer. Specifically, the solvent that remains in the liquid composition layer is heated and dried by a heater 703 of the heating process device 130A. Accordingly, the solvent is removed from the liquid composition layer. Thus, the electrode composite layer is formed. The heating process device 130A may perform the solvent removing process under reduced pressure.

The heater 703 is not limited to any particular heater and may be appropriately selected depending on the intended purpose.

For example, the heater 703 may be a substrate heater, an infrared (IR) heater, a hot air heater, or the like.

The heater 703 may be a combination of at least two of the substrate heater, the IR heater, and the hot air heater. A heating temperature and heating time can be appropriately selected according to the boiling point of the solvent contained in the liquid composition 707 or the thickness of a formed film.

The electrode manufacturing apparatus according to the embodiments of the present invention is used to discharge the liquid composition to a desired position on the discharge target. The electrode composite layer can be suitably used, for example, as a part of the configuration of an electrochemical element. The configuration of the electrochemical element other than the electrode composite layer is not particularly limited, and a known configuration can be appropriately selected. Examples of the configuration other than the electrode composite layer include a positive electrode, a negative electrode, and a separator.

The above-described term “medium onto which liquid can adhere” represents a medium on which liquid is at least temporarily adhered, a medium on which liquid is adhered and fixed, or a medium into which liquid adheres and permeates. Specific examples of the “medium onto which liquid can adhere” include, but are not limited to, a recording medium such as a paper sheet, recording paper, a recording sheet of paper, a film, or cloth, an electronic component such as an electronic substrate or a piezoelectric element, and a medium such as layered powder, an organ model, or a testing cell. The “medium onto which liquid can adhere” includes any medium to which liquid adheres, unless otherwise specified.

The material of the “material to which liquid can adhere” may be any material as long as liquid can adhere even temporarily, such as paper, thread, fiber, cloth, leather, metal, plastic, glass, wood, or ceramics.

The term “liquid discharge apparatus” may be an apparatus in which the liquid discharge head and the medium onto which liquid can adhere move relative to each other. However, the liquid discharge apparatus is not limited to such an apparatus. For example, the liquid discharge apparatus may be a serial head apparatus that moves the liquid discharge head or a line head apparatus that does not move the liquid discharge head.

Examples of the liquid discharge apparatus further include: a treatment liquid applying apparatus that discharges a treatment liquid onto a sheet to apply the treatment liquid to the surface of the sheet, for reforming the surface of the sheet; and an injection granulation apparatus that injects a composition liquid, in which a raw material is dispersed in a solution, through a nozzle to granulate fine particles of the raw material.

The terms “image formation”, “recording”, “text printing”, “printing”, “image printing”, and “fabricating” used herein may be used synonymously with each other.

Although the preferred embodiment has been described in detail above, the present invention is not limited to the above-described embodiment of the present invention, and various modifications and substitutions can be made to the above-described embodiment of the present invention without departing from the scope described in the claims.

All numbers such as ordinal numbers and quantity used in the description of the embodiments of the present invention are exemplified to specifically describe the technology of the present invention, and the present invention is not limited to the exemplified numbers. A connection relation between the components is exemplified for the purpose of describing the technology of the embodiments of the present invention, and the connection relation to enable the functions of the present invention is not limited to the connection relation as described above.

Aspects of the present embodiment are, for example, as follows.

### Aspect 1

According to Aspect 1, a liquid circulation device that circulates liquid and supplies the liquid to a supply target includes: a supply unit that includes a supply tank that stores the liquid to be supplied to the supply target and a collection tank that stores the liquid collected from the supply target, and supplies the liquid to the supply target by a differential pressure between the supply tank and the collection tank; a liquid feed pump that feeds the liquid from the collection tank to the supply tank; a positive pressure pump that supplies gas to the supply tank; a negative pressure pump that sucks gas from the collection tank; and an air feed pump that supplies the gas in the supply tank into the collection tank.

### Aspect 2

According to Aspect 2, in the liquid circulation device of Aspect 1, a start timing of a liquid feeding operation by the liquid feed pump is equal to a start timing of an air feeding operation by the air feed pump.

### Aspect 3

According to Aspect 3, in the liquid circulation device of Aspect 2, an end timing of the liquid feeding operation by the liquid feed pump is equal to an end timing of the air feeding operation by the air feed pump.

### Aspect 4

According to Aspect 4, in the liquid circulation device of Aspect 3, an amount of the liquid fed by the liquid feed pump from the start timing of the liquid feeding operation to the end timing of the liquid feeding operation is equal to an amount of the gas fed by the air feed pump from the start timing of the air feeding operation to the end timing of the air feeding operation.

### Aspect 5

According to Aspect 5, in the liquid circulation device of Aspect 4, the liquid feed pump periodically performs the liquid feeding operation, the air feed pump periodically performs the air feeding operation, and a phase of a flow rate change of the liquid fed by the liquid feeding operation by the liquid feed pump is same as a phase of a flow rate change of the liquid fed by the air feeding operation by the air feed pump.

### Aspect 6

According to Aspect 6, the liquid circulation device of any one of Aspect 1 to Aspect 5 further includes: a replenishment tank that stores the liquid replenished to the collection tank; and a replenishment pump that feeds the liquid from the replenishment tank to the collection tank to replenish the liquid, in which respective start timings of an intake operation by the negative pressure pump, a liquid feeding operation by the liquid feed pump, an air feeding operation by the air feed pump, and a replenishment operation by the replenishment pump are equal to each other.

### Aspect 7

According to Aspect 7, in the liquid circulation device of Aspect 7, respective end timings of the intake operation by the negative pressure pump, the liquid feeding operation by the liquid feed pump, the air feeding operation by the air feed pump, and the replenishment operation by the replenishment pump are equal to each other.

### Aspect 8

According to Aspect 8, in the liquid circulation device of Aspect 7, an amount of gas sucked by the negative pressure pump from the start timing of an intake operation to the end timing of the intake operation, an amount of liquid fed by the liquid feed pump from the start timing of the liquid feeding operation to the end timing of the liquid feeding operation, an amount of gas supplied by the air feed pump from the start timing of the air feeding operation to the end timing of the air feeding operation, and an amount of liquid fed by the replenishment pump from the start timing of the replenishment operation to the end timing of the replenishment operation are equal to each other.

### Aspect 9

According to Aspect 9, in the liquid circulation device of Aspect 8, the negative pressure pump periodically performs the intake operation, and the liquid feed pump periodically performs the liquid feeding operation, the air feed pump periodically performs an air feeding operation, the replenishment pump periodically performs the replenishment operation, and a phase of a flow rate change of the gas sucked by the intake operation of the negative pressure pump, a phase of a flow rate change of the liquid fed by the liquid feeding operation of the liquid feed pump, a phase of a flow rate change of the gas fed by the air feeding operation of the air feed pump, and a phase of a flow rate change of the liquid fed by the replenishment operation of the replenishment pump are equal to each other.

### Aspect 10

According to Aspect 10, a liquid discharge apparatus includes: the liquid circulation device of any one of Aspect 1 to Aspect 9; and a liquid discharge head that is the supply target and discharges the liquid supplied from the liquid circulation device.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

1. A liquid circulation device comprising:
a supply unit including:
a supply tank to store a liquid to be supplied to a supply target; and
a collection tank to store the liquid collected from the supply target;
a liquid feed pump to feed the liquid from the collection tank to the supply tank;
a positive pressure pump to supply gas to the supply tank;
a negative pressure pump to suck gas from the collection tank; and
an air feed pump to supply the gas in the supply tank into the collection tank,
wherein the supply unit supplies the liquid to the supply target by a differential pressure between the supply tank and the collection tank.

2. The liquid circulation device according to claim 1, wherein a start timing of a liquid feeding operation by the liquid feed pump is equal to a start timing of an air feeding operation by the air feed pump.

3. The liquid circulation device according to claim 2, wherein an end timing of the liquid feeding operation by the liquid feed pump is equal to an end timing of the air feeding operation by the air feed pump.

4. The liquid circulation device according to claim 3, wherein an amount of the liquid fed by the liquid feed pump from the start timing of the liquid feeding operation to the end timing of the liquid feeding operation is equal to an amount of the gas fed by the air feed pump from the start timing of the air feeding operation to the end timing of the air feeding operation.

5. The liquid circulation device according to claim 4,
wherein the liquid feed pump periodically performs the liquid feeding operation,
the air feed pump periodically performs the air feeding operation, and
a phase of a flow rate change of the liquid fed by the liquid feeding operation by the liquid feed pump is same as a phase of a flow rate change of the liquid fed by the air feeding operation by the air feed pump.

6. The liquid circulation device according to claim 1, further comprising:
a replenishment tank to store the liquid replenished to the collection tank; and
a replenishment pump to feed the liquid from the replenishment tank to the collection tank to replenish the liquid,
wherein respective start timings of an intake operation by the negative pressure pump, a liquid feeding operation by the liquid feed pump, an air feeding operation by the air feed pump, and a replenishment operation by the replenishment pump are equal to each other.

7. The liquid circulation device according to claim 6, wherein respective end timings of the intake operation by the negative pressure pump, the liquid feeding operation by the liquid feed pump, the air feeding operation by the air feed pump, and the replenishment operation by the replenishment pump are equal to each other.

8. The liquid circulation device according to claim 7,
wherein an amount of gas sucked by the negative pressure pump from the start timing of the intake operation to the end timing of the intake operation,
an amount of liquid fed by the liquid feed pump from the start timing of the liquid feeding operation to the end timing of the liquid feeding operation,
an amount of gas supplied by the air feed pump from the start timing of the air feeding operation to the end timing of the air feeding operation, and
an amount of liquid fed by the replenishment pump from the start timing of the replenishment operation to the end timing of the replenishment operation are equal to each other.

9. The liquid circulation device according to claim 8,
wherein the negative pressure pump periodically performs the intake operation, and
the liquid feed pump periodically performs the liquid feeding operation,
the air feed pump periodically performs the air feeding operation,
the replenishment pump periodically performs the replenishment operation, and
a phase of a flow rate change of the gas sucked by the intake operation of the negative pressure pump, a phase of a flow rate change of the liquid fed by the liquid feeding operation of the liquid feed pump, a phase of a flow rate change of the gas fed by the air feeding operation of the air feed pump, and a phase of a flow rate change of the liquid fed by the replenishment operation of the replenishment pump are equal to each other.

10. A liquid discharge apparatus comprising:
the liquid circulation device according to claim 1; and
a liquid discharge head to discharge the liquid supplied from the liquid circulation device, the liquid discharge head being the supply target.
